(19) United States
(12) Patent Application Publication
(10) Pub. No.: US 2021/0197488 A1
(43) Pub. Date: Jul. 1, 2021

(54) THREE-DIMENSIONAL FORMING WITH FUNCTIONAL ELEMENTS

(71) Applicant: HEWLETT-PACKARD DEVELOPMENT COMPANY, L.P., Spring, TX (US)

(72) Inventor: Will ALLEN, Corvallis, OR (US)

(73) Assignee: HEWLETT-PACKARD DEVELOPMENT COMPANY, L.P., Houston, TX (US)

(21) Appl. No.: 16/077,543

(22) PCT Filed: Apr. 28, 2017
(86) PCT No.: PCT/US2017/030095

§ 371 Date: Aug. 13, 2018

(51) Int. Cl. B29C 64/393; B29C 64/10

(52) U.S. Cl. CPC B29C 64/393; B33Y 10/00; B29C 64/10

(57) ABSTRACT

A system for three-dimensional forming of an object includes a set of functional elements, with each of the functional elements including a housing and a processor, memory, power supply, sensor, and wireless communication module each within the housing, a position module to determine an individual position of each of the functional elements, and a fuse module to determine instructions to fuse selective ones of the functional elements based on the individual position of each of the functional elements to form the object with the selective ones of the functional elements.

### BACKGROUND

The Internet of Things (IoT) may include smart objects with embedded technology to sense, communicate and/or interact with their internal states, each other, and/or their external environment.

### BRIEF DESCRIPTION OF THE DRAWINGS

FIG. 1 is a block diagram illustrating an example of a functional element.

FIG. 2 is a schematic illustration of an example of a plurality of functional elements.

FIG. 3 is a block diagram illustrating an example of determining a pose of a functional element.

FIGS. 4A, 4B, 4C schematically illustrate an example of determining a position of a functional element.

FIGS. 5A, 5B, 5C schematically illustrate another example of determining a position of a functional element.

FIGS. 6A, 6B schematically illustrate an example of determining an orientation of a functional element.

FIGS. 7A, 7B schematically illustrate another example of determining an orientation of a functional element.

FIGS. 8A and 8B are flow diagrams illustrating an example of a method of determining a pose of a functional element.

FIG. 9 is a block diagram illustrating an example of three-dimensional forming of an object.

FIGS. 10A, 10B, 10C schematically illustrate examples of three-dimensional forming of an object.

FIGS. 11A and 11B, 12A and 12B, 13A and 13B, 14A and 14B, 15A, 15B and 15C, 16A and 16B schematically illustrate examples of fusing functional elements.

FIG. 17 is a flow diagram illustrating an example of a method of three-dimensional forming of an object.

### DETAILED DESCRIPTION

The present disclosure provides for fusing of functional elements. In one implementation, as described herein, functional elements are individually addressed and instructed to selectively fuse (e.g., join, unite, link, connect, couple, bind, adhere) to adjacent functional elements. More specifically, a set of commands or instructions are transmitted to functional elements to cause any number of adjacent (i.e., touching, abutting, contiguous, neighboring, close to, near, next to, by, by the side of, bordering on, beside) functional elements to fuse together. As such, a dynamic formable three-dimensional modeling system is created that provides for direct parallel formation of a three-dimensional object (i.e., the individual fusing of multiple functional elements to form a three-dimensional object occurs substantially simultaneously). Such a system allows for forming of a three-dimensional object all at once (versus in passes or layers) thereby providing virtually instant three-dimensional fabrication.

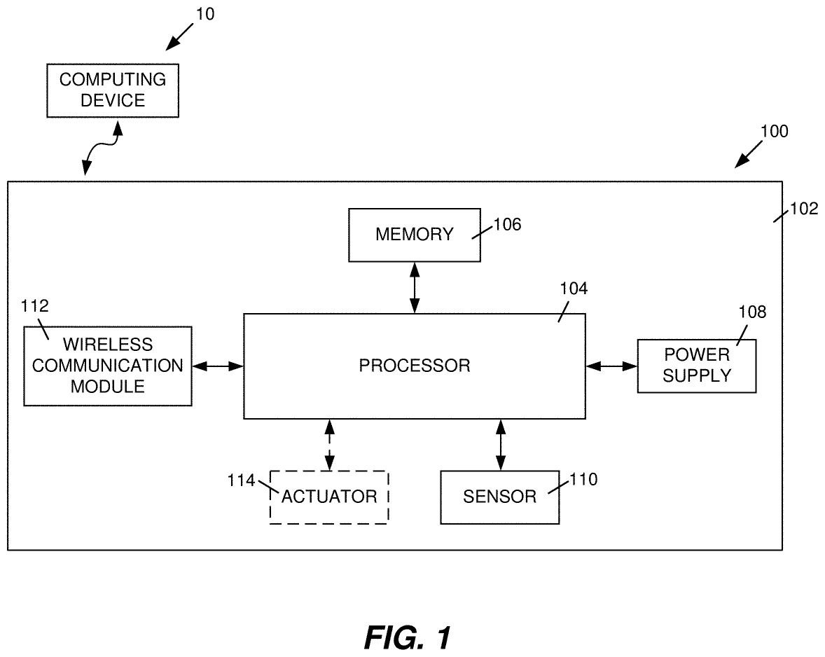

FIG. 1 is a block diagram illustrating an example of a functional element 100. In one implementation, functional element 100 includes a shell or housing 102 with components, such as a processor 104, memory 106, power supply 108, sensor 110, and wireless communication module 112, provided within housing 102.

Processor 104 transfers, communicates, and/or processes signals, commands, conditions, states, and/or parameters for and/or between components of functional element 100, and may include analog and/or digital elements and/or circuits. In examples, processor 104 implements and/or executes computer-readable, computer-executable instructions for data processing functions and/or functionality of functional element 100. In examples, such instructions are stored in memory, such as memory 106.

Memory 106 may include volatile and non-volatile memory, and includes a non-transitory computer-readable storage medium suitable for tangibly embodying program instructions and data. Power supply 108 provides energy for operating components of functional element 100. In one implementation, power supply 108 is a rechargeable battery.

Sensor 110 provides information about one or more than one operating and/or environmental condition and/or state of functional element 100. In examples, sensor 110 includes one or more than one instrument or device for reading, detecting, measuring, indicating, and/or responding to a condition and/or state of functional element 100, including, for example, position, orientation, gravitational force, magnetic force, and/or ambient or environmental conditions such as temperature, humidity, and/or pressure.

Wireless communication module 112 facilitates the exchange and/or transmission of information and/or data between functional element 100 and another device or system, including an external device such as, for example, computing device 10. Such information and/or data may include, for example, control and/or logic instructions or commands, condition or state information, as well as other information and/or data to be exchanged with and/or transmitted to and/or from functional element 100.

In some examples, functional element 100 includes an actuator 114. Actuator 114 includes, operates, and/or controls one or more than one mechanism or mechanical element, component, or system of functional element 100.

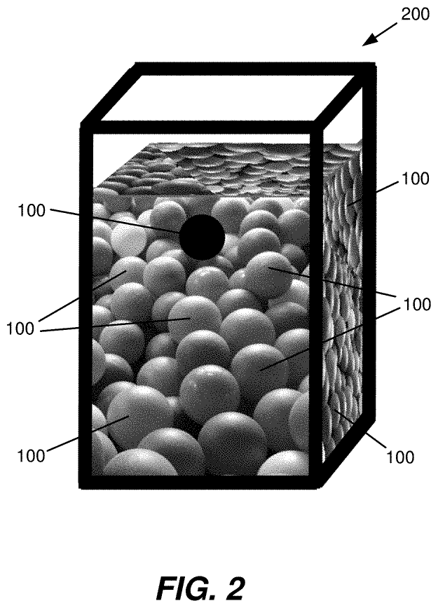

FIG. 2 is a schematic illustration of an example of a plurality of functional elements 100. In one implementation, functional elements 100 are individually addressable such that information and/or data of and/or for each functional element 100 of the plurality of functional elements 100 may be serialized or individualized. As such, information and/or data exchanged with and/or transmitted to and/or from an individual functional element 100, for example, via wireless communication module 112, may be recognized and/or identified as being from a specific functional element 100. For example, as described below, a pose (position/location and/or orientation) of a functional element 100 (of a plurality of functional elements 100) may be individually determined and serialized such that transmission of the determined pose may be recognized and/or identified as being of a specific functional element 100.

As illustrated in the example of FIG. 2, a collection, set, accumulation, or grouping of functional elements 100 is provided or established. In one implementation, functional elements 100 are spherical in shape. Functional elements 100, however, may be of other shapes, including, for example, polyhedral shapes, such as dodecahedral. In addition, functional elements 100 may be irregularly shaped, and may be of different shapes and/or different sizes relative to each other.

In the illustrated example, functional elements 100 are held or contained by or within an enclosure or container 200. Although illustrated as being a rectangular prism, container 200 may be of other shapes and/or sizes. In other examples, functional elements 100 are accumulated, grouped, and/or maintained in a pile or mound without an enclosure or container.

It is to be understood that FIG. 2 is a schematic representation of a collection, set, accumulation, or grouping of functional elements 100 within container 200. Although illustrated with a void between a top of the functional elements 100 and a top of container 200, the void may be filled with additional functional elements and/or a fill material. In addition, the number of functional elements 100 within container 200 may vary such that the number of functional elements 100 within container 200 may be more or less than that illustrated.

In one example, the collection, set, accumulation, or grouping of functional elements 100 is random such that an initial pose of each functional element 100, for example, within container 200, is unknown. In one implementation, each functional element 100 includes six degrees of freedom, namely translation in three perpendicular axes and rotation about the three perpendicular axes. As such, a pose of each functional element 100 includes three degrees of position (location) and three degrees of orientation. For example, the three degrees of position include x, y, and z coordinates, and the three degrees of orientation include degrees of rotation about x, y, and z axes. More specifically, the three degrees of position include, for example, surge (movement forward and backward along an x-axis), sway (movement left and right along a y-axis), and heave (movement up and down along a z-axis), and the three degrees of orientation include, for example, roll (tilting side to side about the x-axis), pitch (tilting forward and backward about the y-axis), and yaw (left and right turning about the z-axis). With a collection, set, accumulation, or grouping of functional elements 100, the pose of each functional element 100 may be established relative to each other and/or relative to an environment or surrounding, such as container 200.

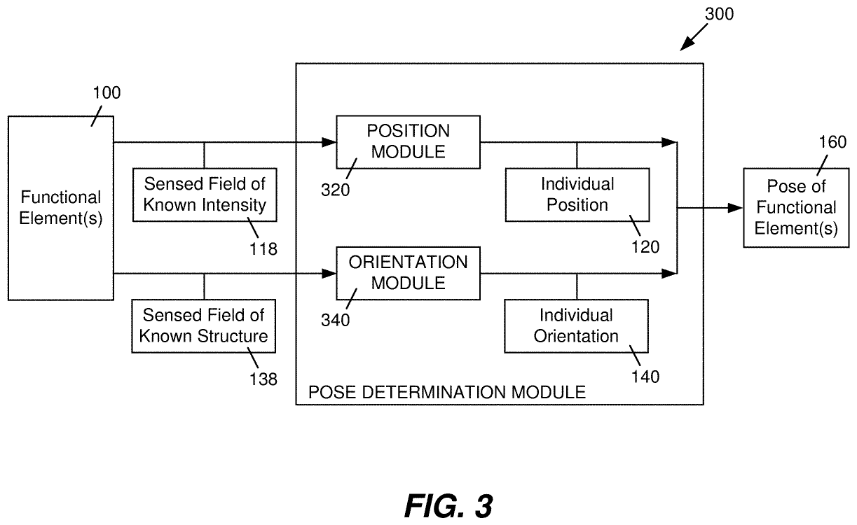

FIG. 3 is a block diagram illustrating an example of determining a pose of a functional element. In examples, as described below, a pose determination unit or module 300 determines a pose of a functional element 100, including an individual position and an individual orientation of a respective functional element 100, based on a condition or conditions sensed by a respective functional element 100.

In one implementation, as schematically illustrated in FIG. 3, pose determination module 300 includes a position unit or module 320, and an orientation unit or module 340. As described below, position module 320 determines an individual position 120 of a respective functional element 100, and orientation module 340 determines an individual orientation 140 of a respective functional element 100, such that an individual pose 160 of the respective functional element 100 may be established from individual position 120 and individual orientation 140.

Pose determination module 300 includes hardware, software, firmware, or a combination of these. In one implementation, pose determination module 300 is included in a computer, computer server, or other microprocessor-based system capable of performing a sequence of logic operations. Components of pose determination module 300, including position module 320, and/or orientation module 340, can be implemented in hardware via a microprocessor, programmable logic device, or state machine, in firmware, or in software within a given device. Position module 320, and/or orientation module 340 may be implemented, for example, as a subroutine of a computer program. Pose determination module 300, including position module 320, and/or orientation module 340, can be implemented, wholly or in part, on a respective functional element 100 or on an external device, such as computing device 10 (FIG. 1).

In one implementation, position module 320 determines individual position 120 based on a field with a known intensity sensed by a respective functional element 100, as described below. As such, position module 320 receives, as input, a measure of a sensed field of known intensity 118 from a respective functional element 100. The field of known intensity may be sensed, for example, by an implementation of sensor 110 (FIG. 1) of a respective functional element 100. In one implementation, the measure of the sensed field of known intensity 118 is transmitted or communicated to pose determination module 300, including, more specifically, position module 320, via wireless communication module 112 (FIG. 1) of the respective functional element 100.

In one implementation, orientation module 340 determines individual orientation 140 based on a field with a known structure sensed by a respective functional element 100, as described below. As such, orientation module 340 receives, as input, a measure of a sensed field of known structure 138 from a respective functional element 100. The field of known structure may be sensed, for example, by an implementation of sensor 110 (FIG. 1) of a respective functional element 100. In one implementation, the measure of the sensed field of known structure 138 is transmitted or communicated to pose determination module 300, including, more specifically, orientation module 340, via wireless communication module 112 (FIG. 1) of the respective functional element 100.

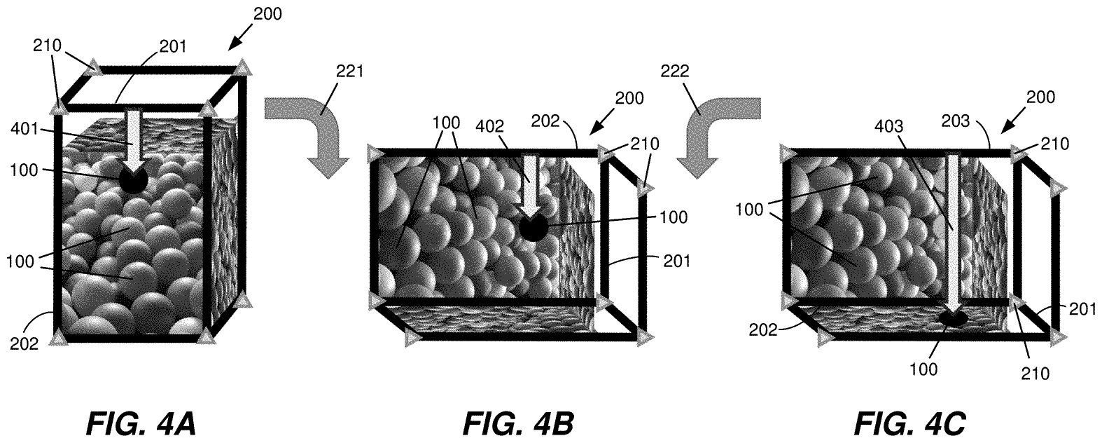

FIGS. 4A, 4B, 4C schematically illustrate an example of determining a position of a functional element, such as individual position 120 of a respective functional element 100. In one example, as described above, determination of individual position 120 is based on a field with a known intensity, including, more specifically, a field with a known intensity profile, intensity gradient, or three-dimensional intensity. In one implementation, the field of known intensity is ambient pressure, including, more specifically, atmospheric pressure (i.e., air pressure or gas pressure). As such, the field of known intensity may be sensed, for example, by an altimeter, as an example of sensor 110 of a respective functional element 100.

As illustrated in the example of FIG. 4A, container 200, with functional elements 100 therein, is positioned in or has a first orientation. With the first orientation, atmospheric pressure at a respective functional element 100 is measured such that a “depth” or position of the respective functional element 100 relative to a first surface, face, or boundary of container 200, such as boundary 201, is resolved, as represented, for example, by arrow 401. As such, a first positional coordinate, such as an x-coordinate, of the respective functional element 100 is determined. In one implementation, container 200 includes a transmitter or sensor 210 at one or more known locations such that a sensed measurement by a respective functional element 100 is compared with a sensed measurement by sensor 210.

As illustrated in the example of FIG. 4B, container 200, with functional elements 100 therein, is positioned in or has a second orientation. With the second orientation, atmospheric pressure at the respective functional element 100 is measured such that a “depth” or position of the respective functional element 100 relative to a second surface, face, or boundary of container 200, such as boundary 202, is resolved, as represented, for example, by arrow 402. As such, a second positional coordinate, such as a y-coordinate, of the respective functional element 100 is determined.

As illustrated in the example of FIG. 4C, container 200, with functional elements 100 therein, is positioned in or has a third orientation. With the third orientation, atmospheric pressure at the respective functional element 100 is measured such that a “depth” or position of the respective functional element 100 relative to a third surface, face, or boundary of container 200, such as boundary 203, is resolved, as represented, for example, by arrow 403. As such, a third positional coordinate, such as a z-coordinate, of the respective functional element 100 is determined.

In one example, container 200, with functional elements 100 fixed therein, is re-oriented or rotated, as represented by arrow 221, between the first orientation of FIG. 4A and the second orientation of FIG. 4B, and re-oriented or rotated, as represented by arrow 222, between the second orientation of FIG. 4B and the third orientation of FIG. 4C. In one implementation, container 200 is rotated ninety degrees between the first orientation and the second orientation, and rotated ninety degrees between the second orientation and the third orientation such that the second orientation of FIG. 4B is orthogonal to the first orientation of FIG. 4A, and the third orientation of FIG. 4C is orthogonal to both the first orientation of FIG. 4A and the second orientation of FIG. 4B. Although illustrated as being rotated ninety degrees between the first orientation and the second orientation, and rotated ninety degrees between the second orientation and the third orientation, container 200, with functional elements 100 fixed therein, may be rotated a different amount (or amounts) between the first orientation and the second orientation, and/or between the second orientation and the third orientation such that the rotation (or rotations) include a non-zero orthogonal vector component (e.g., 30 degrees, 120 degrees).

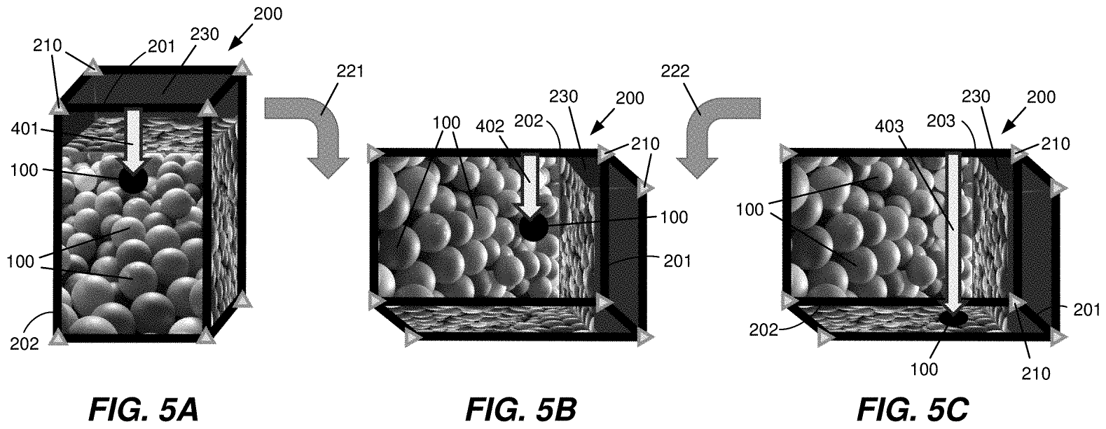

FIGS. 5A, 5B, 5C schematically illustrate another example of determining a position of a functional element, such as individual position 120 of a respective functional element 100. In one example, as described above, determination of individual position 120 is based on a field with a known intensity, including, more specifically, a field with a known intensity profile, intensity gradient, or three-dimensional intensity. In one implementation, the field of known intensity is ambient pressure, including, more specifically, liquid pressure (e.g., water pressure). As such, the field of known intensity may be sensed, for example, by a liquid pressure sensor or transducer or hydrostatic depth sensor, as an example of sensor 110 of a respective functional element 100.

As illustrated in the example of FIG. 5A, container 200, with functional elements 100 therein, is positioned in or has a first orientation, and is filled with a liquid 230, such as water, oil, alcohol, acetone, mercury or other liquid or liquid mixture, such that functional elements 100 are submerged in liquid 230. With the first orientation, liquid pressure at a respective functional element 100 is measured such that a “depth” or position of the respective functional element 100 relative to a first surface, face, or boundary of container 200, such as boundary 201, is resolved, as represented, for example, by arrow 401. As such, a first positional coordinate, such as an x-coordinate, of the respective functional element number 100 is determined. In one implementation, container 200 includes a transmitter or sensor 210 at one or more known locations such that a sensed measurement by a respective functional element 100 is compared with a sensed measurement by sensor 210.

As illustrated in the example of FIG. 5B, container 200, with functional elements 100 submerged in liquid 230 therein, is positioned in or has a second orientation. With the second orientation, liquid pressure at the respective functional element 100 is measured such that a “depth” or position of the respective functional element 100 relative to a second surface, face, or boundary of container 200, such as boundary 202, is resolved, as represented, for example, by arrow 402. As such, a second positional coordinate, such as a y-coordinate, of the respective functional element 100 is determined.

As illustrated in the example of FIG. 5C, container 200, with functional elements 100 submerged in liquid 230 therein, is positioned in or has a third orientation. With the third orientation, liquid pressure at the respective functional element 100 is measured such that a “depth” or position of the respective functional element 100 relative to a third surface, face, or boundary of container 200, such as boundary 203, is resolved, as represented, for example, by arrow 403. As such, a third positional coordinate, such as a z-coordinate, of the respective functional element 100 is determined.

Similar to the example of FIGS. 4A, 4B, 4C, container 200, with functional elements 100 fixed and submerged in liquid 230 therein, is re-oriented or rotated, as represented by arrow 221, between the first orientation of FIG. 5A and the second orientation of FIG. 5B, and re-oriented or rotated, as represented by arrow 222, between the second orientation of FIG. 5B and the third orientation of FIG. 5C. Although illustrated as being rotated ninety degrees between the first orientation and the second orientation, and rotated ninety degrees between the second orientation and the third orientation, container 200, with functional elements 100 fixed and submerged in liquid 230 therein, may be rotated a different amount (or amounts) between the first orientation and the second orientation, and/or between the second orientation and the third orientation such that the rotation (or rotations) include a non-zero orthogonal vector component (e.g., 30 degrees, 120 degrees).

In the examples described above, the field of known intensity is ambient pressure, including, more specifically, atmospheric pressure (i.e., air pressure or gas pressure) and liquid pressure (e.g., water pressure). In other examples, the field of known intensity may include light or radio signals directed from or generated by a respective source. As such, and similar to the examples of FIGS. 4A, 4B, 4C, and FIGS. 5A, 5B, 5C, container 200, with functional elements 100 fixed therein, may be re-oriented or rotated between a first orientation, a second orientation, and a third orientation, and the field of known intensity (e.g., light intensity or radio signal strength) may be sensed by a respective functional element 100 such that a position of the respective functional element 100 may be determined.

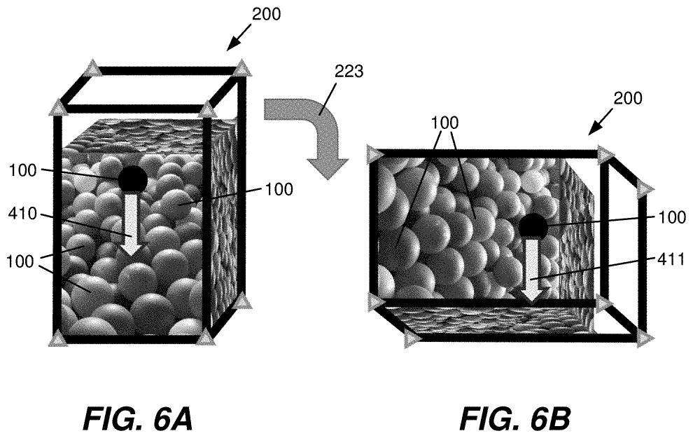

FIGS. 6A, 6B schematically illustrate an example of determining an orientation of a functional element, such as individual orientation 140 of a respective functional element 100. In one example, as described above, determination of individual orientation 140 is based on a field with a known structure. In one implementation, the field of known structure is a gravitational field. As such, the field of known structure may be sensed, for example, by an accelerometer or tilt sensor, as an example of sensor 110 of a respective functional element 100.

As illustrated in the example of FIG. 6A, container 200, with functional elements 100 therein, is positioned in or has a first orientation. With the first orientation, a direction of the gravitational field (i.e., a direction of gravitational force), as represented, for example, by arrow 410 (i.e., “down”), is sensed by a respective functional element 100. As such, a first orientation parameter relative to the sensed direction of the gravitational field, such as roll, and a second orientation parameter relative to the sensed direction of the gravitational field, such as pitch, of the respective functional element 100 is determined.

As illustrated in the example of FIG. 6B, container 200, with functional elements 100 therein, is positioned in or has a second orientation. With the second orientation, a direction of the gravitational field (i.e., a direction of gravitational force), as represented, for example, by arrow 411 (i.e., “down”), is sensed by the respective functional element 100. As such, a third orientation parameter relative to the sensed direction of the gravitational field, such as yaw, of the respective functional element 100 is determined.

In one example, container 200, with functional elements 100 fixed therein, is re-oriented or rotated, as represented by arrow 223, between the first orientation of FIG. 6A and the second orientation of FIG. 6B. In one implementation, the second orientation of FIG. 6B is orthogonal to the first orientation of FIG. 6A such that container 200 is rotated ninety degrees between the first orientation and the second orientation.

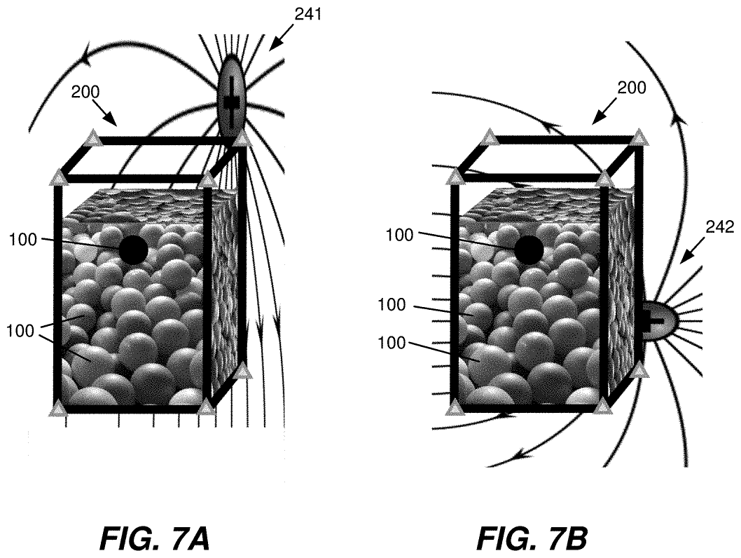

FIGS. 7A, 7B schematically illustrate another example of determining an orientation of a functional element, such as individual orientation 140 of a respective functional element 100. In one example, as described above, determination of individual orientation 140 is based on a field with a known structure. In one implementation, the field of known structure is a magnetic field. As such, the field of known structure may be sensed, for example, by a magnetometer, as an example of sensor 110 of a respective functional element 100.

As illustrated in the example of FIG. 7A, container 200, with functional elements 100 therein, is positioned in a magnetic field 241 having a first orientation. With the first orientation of magnetic field 241, an orientation of the magnetic field is sensed by a respective functional element 100 such that a first orientation parameter, such as roll, and a second orientation parameter, such as pitch, of the respective functional element 100 is determined.

As illustrated in the example of FIG. 7B, container 200, with functional elements 100 therein, is positioned in a magnetic field 242 having a second orientation. With the second orientation of magnetic field 242, an orientation of the magnetic field is sensed by the respective functional element 100 such that a third orientation parameter, such as yaw, of the respective functional element 100 is determined.

In one implementation, the orientation of magnetic field 242 of FIG. 7B is orthogonal to the orientation of magnetic field 241 of FIG. 7A, and is established by re-orienting or rotating a magnetic field ninety degrees relative to functional elements 100, for example, relative to container 200, with functional elements 100 therein. As such, the first orientation includes a first orientation of the field of known structure (i.e., magnetic field), and the second orientation includes a second orientation of the field of known structure (i.e., magnetic field) rotated relative to the first orientation of the field of known structure. In another implementation, container 200, with functional elements 100 fixed therein, is re-oriented or rotated ninety degrees relative to a magnetic field to establish a first orientation of the magnetic field and a second orientation of the magnetic field relative to container 200 and functional elements 100.

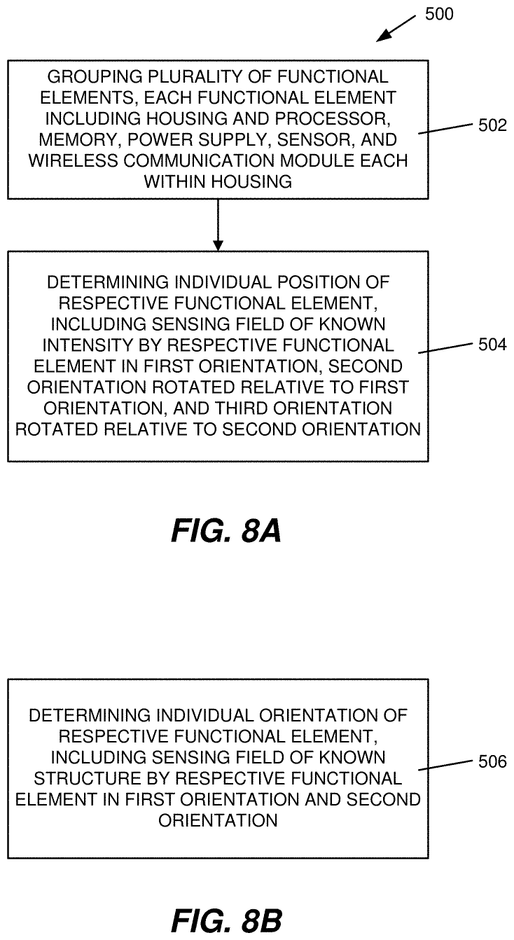

FIGS. 8A and 8B are flow diagrams illustrating an example of a method 500 of determining a pose of a functional element, such as functional element 100, as schematically illustrated, for example, in FIG. 1.

In one example, as illustrated in FIG. 8A, at 502, method 500 includes grouping a plurality of functional elements, such as functional elements 100, with each of the functional elements including a housing, such as housing 102, and a processor, such as processor 104, memory, such as memory 106, power supply, such as power supply 108, sensor, such as sensor 110, and wireless communication module, such as wireless communication module 112, each within the housing, as schematically illustrated, for example, in FIG. 1.

As such, in one example, at 504, method 500 includes determining an individual position of a respective one of the functional elements, such as individual position 120 of a respective functional element 100. In one example, determining an individual position of a respective one of the functional elements includes sensing a field of known intensity by the respective one of the functional elements in each a first orientation, a second orientation rotated relative to the first orientation, and a third orientation rotated relative to the second orientation, as schematically illustrated, for example, in FIGS. 4A, 4B, 4C, and FIGS. 5A, 5B, 5C.

In one implementation, sensing the field of known intensity, for example, at 504, includes sensing atmospheric pressure by the respective one of the functional elements in each the first orientation, the second orientation, and the third orientation, as schematically illustrated, for example, in FIGS. 4A, 4B, 4C.

In another implementation, method 500 includes submerging the functional elements in liquid, such that sensing the field of known intensity, for example, at 504, includes sensing liquid pressure by the respective one of the functional elements in each the first orientation, the second orientation, and the third orientation, as schematically illustrated, for example, in FIGS. 5A, 5B, 5C.

In one example, as illustrated in FIG. 8B, at 506, method 500 further includes determining an individual orientation of the respective one of the functional elements, such as individual orientation 140 of a respective functional element 100. In one example, determining an individual orientation of the respective one of the functional elements includes sensing a field of known structure by the respective one of the functional elements in both the first orientation and the second orientation, as schematically illustrated, for example, in FIGS. 6A, 6B, and FIGS. 7A, 7B.

In one implementation, sensing the field of known structure, for example, at 506, includes sensing a direction of a gravitational field by the respective one of the functional elements in both the first orientation and the second orientation, as schematically illustrated, for example, in FIGS. 6A, 6B.

In another implementation, sensing the field of known structure, for example, at 506, includes sensing an orientation of a magnetic field by the respective one of the functional elements in both the first orientation and the second orientation, as schematically illustrated, for example, in FIGS. 7A, 7B.

Although illustrated and described as separate and/or sequential steps, the method may include a different order or sequence of steps, and may combine one or more steps or perform one or more steps concurrently, partially or wholly.

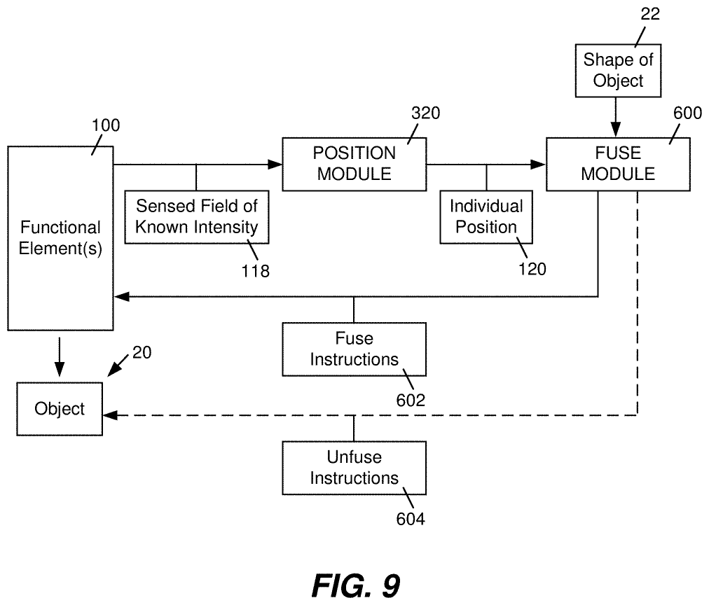

FIG. 9 is a block diagram illustrating an example of three-dimensional forming of an object. In one example, as described below, a fuse module 600 determines, based on a position of functional elements 100, which functional elements 100 of a collection, set, accumulation, or grouping of functional elements 100 are to be fused (e.g., joined, united, linked, connected, coupled) to form an object, namely a three-dimensional object, such as object 20. As such, in one example, select functional elements 100 receive commands or instructions to fuse with specified adjacent functional elements 100, as described below. In one example, fusing of functional elements 100 occurs substantially simultaneously (i.e., in parallel).

In one implementation, as schematically illustrated in FIG. 9, fuse module 600 receives a desired or specified shape 22 of an object to be formed, such as object 20. Shape 22 of an object to be formed may be received, for example, as three-dimensional data (e.g., a three-dimensional graphics file). As such, fuse module 600 determines commands or instructions, such as fuse instructions 602, for fusing select functional elements 100 to form object 20 based on individual position 120 of functional elements 100 and shape 22 of the object to be formed.

In examples, position module 320 determines individual position 120 of functional elements 100 based on a measure of a sensed field of known intensity 118 received from a respective functional element 100, as described above. In some examples, in addition to an individual position of functional elements 100, fuse module 600 determines which functional elements 100 are to be fused to form object 20 based on an individual orientation of functional elements 100. In examples, orientation module 340 (FIG. 3) determines individual orientation 140 of functional elements 100 based on a measure of a sensed field of known structure 138 received from a respective functional element 100, as described above.

In one example, fuse module 600 determines which functional elements 100 are to be fused to form object 20 by virtually positioning shape 22 of object 20 within a three-dimensional space (i.e., volume) of a collection, set, accumulation, or grouping of functional elements 100. As such, in one implementation, each functional element 100 having at least approximately half of a volume thereof within the virtual three-dimensional space is identified. In one example, with functional elements 100 within the virtual three-dimensional space identified, fuse module 600 identities adjacent functional elements 100 within the virtual three-dimensional space. More specifically, in one example, fuse module 600 identities adjacent (i.e., touching, abutting, contiguous, neighboring, close to, near, next to, by, by the side of, bordering on, beside) functional elements 100 (i.e., pair or pairs of functional elements 100) within the virtual three-dimensional space. Accordingly, in one example, fuse module 600 determines fuse instructions 602 based on individual position 120 of adjacent functional elements 100 within the virtual three-dimensional space.

In one example, in virtually positioning shape 22 of the object to be formed within a three-dimensional space of functional elements 100, fuse module 600 scales (e.g., scales down or scales up) shape 22 of the object to be formed to a size no larger than the volume of functional elements 100.

In examples, fuse instructions 602 identify or specify coordinates (i.e., absolute position and/or position within a collection, set, accumulation, or grouping) of functional elements 100 to be fused to form object 20. In one example, fuse instructions 602 specify coordinates (e.g., x, y coordinate pairs) of functional elements 100 to be fused to form object 20 such that relative coordinates of adjacent functional elements 100 to be fused to form object 20 are mapped to the coordinates specified in fuse instructions 602. In another example, fuse instructions 602 specify functional elements 100 to be fused to form object 20 such that functional elements 100 use inter-device (i.e., inter-element) exchange of information to identify and map adjacent functional elements 100 to be fused to form object 20 to the functional elements 100 specified in fuse instructions 602.

In examples, fuse instructions 602 specify a location or locations (i.e., a fuse location or fuse locations) at which a respective functional element 100 is to be fused with an adjacent functional element 100. In one example, fuse instructions 602 are individually addressed to functional elements 100 to be fused to form object 20. As such, in one implementation, fuse instructions 602 include elevation (altitude) and azimuth (i.e., horizontal coordinates) of a location (or locations) at which functional elements 100 are to be fused to form object 20 relative to a current orientation of a respective to-be-fused functional element 100. In one example, individual fuse instructions 602 are transmitted using a unique device ID wireless communications technology (e.g., Bluetooth technology).

In another example, fuse instructions 602 are broadcast in the form of a plurality of data triplets (e.g., ID, azimuth, elevation) such that all functional elements 100 of a collection, set, accumulation, or grouping of functional elements 100 receive fuse instructions 602. However, each functional element 100 only responds to fuse instructions 602 which include an ID matching a unique ID of a respective functional element 100.

In examples, individual functional elements 100 may be fused with multiple other functional elements 100. For example, with functional elements 100 of spherical shape and the same size, a respective functional element 100 may contact up to twelve adjacent functional elements 100. As such, in such example, fuse instructions 602 may specify up to twelve fuse locations for a respective functional element 100.

In one implementation, in addition to issuing fuse instructions 602 for fusing functional elements 100 to form object 20, fuse module 600 issues or communicates commands or instructions, such as unfuse instructions 604, for unfusing (e.g., separating, unlinking, disconnecting, decoupling) functional elements 100 fused to form object 20. As such, in examples, fusing of functional elements 100 is reversible such that functional elements 100 fused to form object 20 may be unfused and combined with other functional elements 100 (e.g., a new or previous collection, set, accumulation, or grouping of functional elements 100).

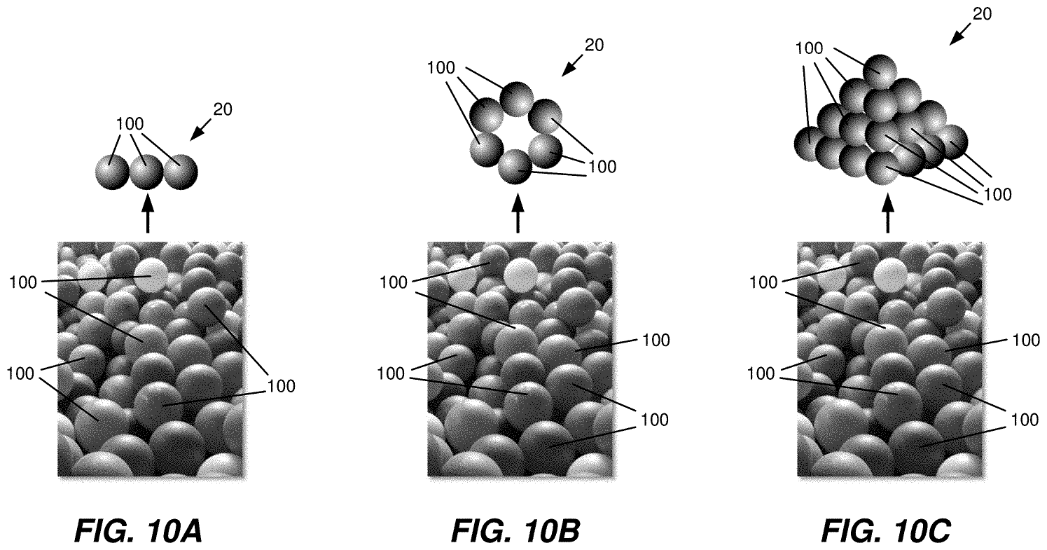

FIGS. 10A, 10B, 10C schematically illustrate examples of three-dimensional forming of an object, such as object 20. In one example, as described above, fuse instructions 602 for fusing functional elements 100 to form an object, namely a three-dimensional object, such as object 20, are communicated, transmitted, or otherwise issued to functional elements 100 of a collection, set, accumulation, or grouping of functional elements 100. As such, in response to fuse instructions 602, select functional elements 100 are fused (e.g., joined, united, linked, connected, coupled) to form object 20. Thus, a three-dimensional object (shape) may be formed and removed from the remaining (i.e., unfused or “loose”) functional elements 100 of the collection, set, accumulation, or grouping of functional elements 100.

In one example, as schematically illustrated in FIG. 10A, object 20 includes a closed-form three-dimensional structure or shape formed of fused functional elements 100. In one example, as schematically illustrated in FIG. 10B, object 20 includes an open-form three-dimensional structure or shape formed of fused functional elements 100. In one example, as schematically illustrated in FIG. 10C, object 20 includes a stacked-form (e.g., pyramidal) three-dimensional structure or shape formed of fused functional elements 100. Other three-dimensional structures, shapes, configurations, formations, constructions, and arrangements of fused functional elements 100, including combinations of structures, shapes, configurations, formations, constructions, and arrangements of fused functional elements 100, are also possible.

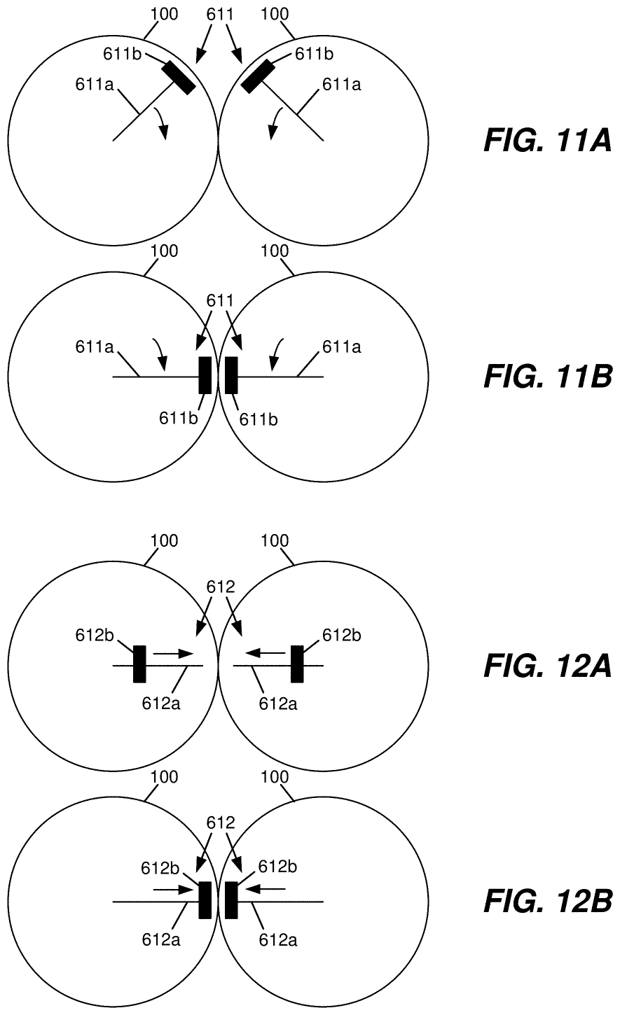

FIGS. 11A and 11B, 12A and 12B, 13A and 13B, 14A and 14B, 15A, 15B and 15C, 16A and 16B schematically illustrate examples of fusing functional elements, such as functional elements 100. In one example, as described above, fuse instructions 602 for fusing functional elements 100 include coordinates of a location (or locations) at which functional elements 100 are to be fused relative to a current orientation of a respective to-be-fused functional element 100. For example, in one implementation, fuse instructions 602 include horizontal coordinates, such as elevation (or altitude) and azimuth, of a fuse location of a respective to-be-fused functional element 100. As such, as described above, select functional elements 100 of a collection, set, accumulation, or grouping of functional elements 100 are fused to adjacent functional elements 100.

FIGS. 11A and 11B schematically illustrate an example of fusing functional elements, such as functional elements 100. In one example, functional elements 100 include positionable fusing elements 611 to fuse adjacent functional elements 100. In one implementation, positionable fusing elements 611 include an internal apparatus or component, such as radial arm or component 611a, within each functional element 100. The internal apparatus or component, as an example of actuator 114 (FIG. 1), may be selectively positioned to a point inside the about-to-fuse functional element 100 corresponding to the received coordinates (e.g., elevation/azimuth). In one example, an inner surface of the shell or housing of functional elements 100 is imprinted with fiducial information (e.g., 2D bar codes marking elevation and azimuth at intervals). As such, a reader or sensor on the internal apparatus or component reads or senses the fiducial information, thereby identifying a position of the internal apparatus or component relative to the shell or housing of a respective functional element 100. Thus, the internal apparatus or component may be moved to the received coordinates (e.g., elevation/azimuth).

In one implementation, positionable fusing elements 611 include a fusing element at or near an end of the internal apparatus or component, such as fusing element 611b at or near an end of radial arm or component 611a. In one example, fusing element 611b includes a magnet such that, when fusing element 611b of one functional element 100 is aligned with appropriately positioned and pole-oriented fusing element 611b of an adjacent functional element 100, as schematically illustrated, for example, in FIG. 11B, fusing element 611b of one functional element 100 is magnetically coupled with fusing element 611b of another functional element 100. As such, adjacent functional elements 100 may be fused together. While one positionable fusing element 611 is illustrated within each functional element 100, the number of positionable fusing elements 611 within each functional element 100 may be more than one.

FIGS. 12A and 12B schematically illustrate an example of fusing functional elements, such as functional elements 100. In one example, functional elements 100 include positionable fusing elements 612 to fuse adjacent functional elements 100. In one implementation, positionable fusing elements 612 include an internal apparatus or component, such as radial arm or component 612a, within each functional element 100. Similar to positionable fusing elements 611, positionable fusing elements 612, as an example of actuator 114 (FIG. 1), may be selectively positioned to a point inside the about-to-fuse functional element 100 corresponding to the received coordinates (e.g., elevation/azimuth).

In one implementation, positionable fusing elements 612 include a fusing element movable along a length of the internal apparatus or component, such as fusing element 612b movable along a length of radial arm or component 612a. In one example, fusing element 612b includes a magnet such that, when aligned and appropriately positioned, as schematically illustrated, for example, in FIG. 12B, fusing element 612b of one functional element 100 is magnetically coupled with fusing element 612b of another functional element 100. As such, adjacent functional elements 100 may be fused together. While one positionable fusing element 612 is illustrated within each functional element 100, the number of positionable fusing elements 612 within each functional element 100 may be more than one.

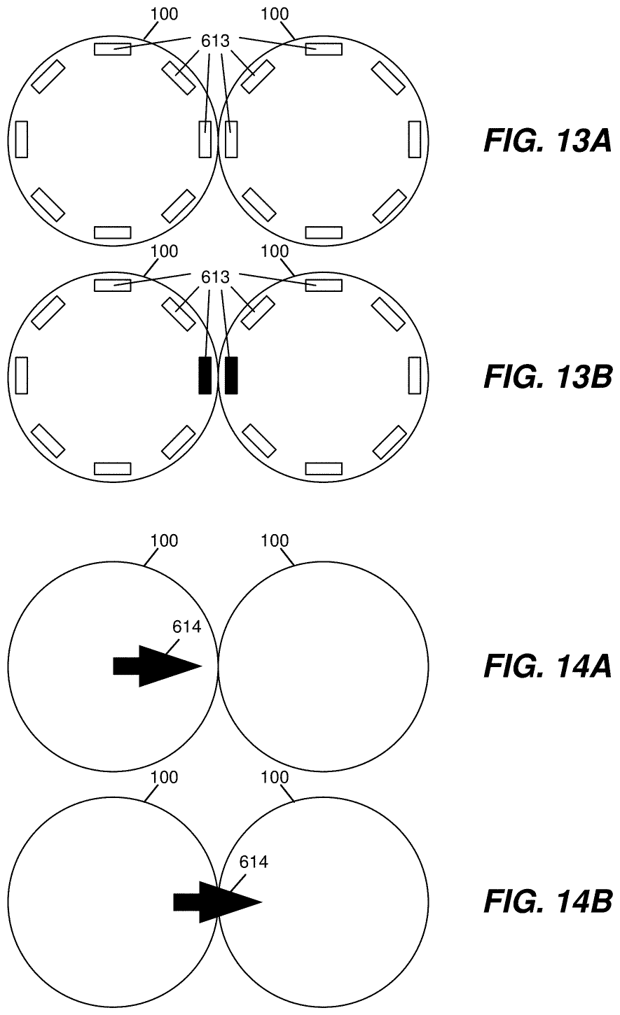

FIGS. 13A and 13B schematically illustrate an example of fusing functional elements, such as functional elements 100. In one example, functional elements 100 include individually addressable fusing elements 613 to fuse adjacent functional elements 100. In one implementation, individually addressable fusing elements 613 include or are provided at spaced regions around or within each functional element 100. As such, individually addressable fusing elements 613 of the about-to-fuse functional elements 100, corresponding to the received coordinates (e.g., elevation/azimuth), may be activated. In one example, individually addressable fusing elements 613 include individually addressable electromagnets or electrostatic elements such that, when activated accordingly, as schematically illustrated, for example, in FIG. 13B, individually addressable fusing element 613 of one functional element 100 is attracted to or coupled with individually addressable fusing element 613 of another functional element 100. As such, adjacent functional elements 100 may be fused together.

FIGS. 14A and 14B schematically illustrate an example of fusing functional elements, such as functional elements 100. In one example, functional elements 100 include penetrable fusing elements 614 to fuse adjacent functional elements 100. In one implementation, penetrable fusing element 614 includes a mechanical fastener, such as a screw or other threaded fastener, initially positioned within a respective functional element 100. Similar to positionable fusing elements 611 and 612, penetrable fusing element 614, as an example of actuator 114 (FIG. 1), may be selectively positioned to a point of the about-to-fuse functional element 100 corresponding to the received coordinates (e.g., elevation/azimuth). In one example, penetrable fusing element 614 may be advanced (e.g., driven or rotated) to penetrate an adjacent functional element 100, as schematically illustrated, for example, in FIG. 14B. As such, adjacent functional elements 100 may be fused together. While one penetrable fusing element 614 is illustrated, the number of penetrable fusing elements 614 within each functional element 100 may be more than one.

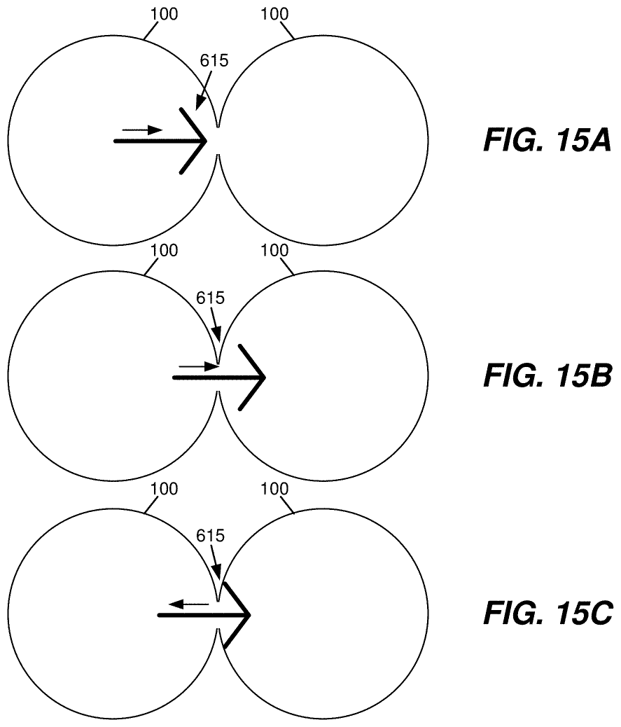

FIGS. 15A, 15B and 15C schematically illustrate an example of fusing functional elements, such as functional elements 100. In one example, functional elements 100 include penetrable fusing elements 615 to fuse adjacent functional elements 100. In one implementation, penetrable fusing element 615 includes a mechanical fastener, such as a hook, barb, anchor, toggle bolt, molly fastener, or other mechanical interlock, initially positioned within a respective functional element 100. Similar to positionable fusing elements 611 and 612, penetrable fusing element 615, as an example of actuator 114 (FIG. 1), may be selectively positioned to a point of the about-to-fuse functional element 100 corresponding to the received coordinates (e.g., elevation/azimuth). In one example, penetrable fusing element 615 may be inserted through aligned holes or openings of adjacent functional elements 100, as schematically illustrated, for example, in FIG. 15B, and retracted, as schematically illustrated, for example, in FIG. 15C. As such, adjacent functional elements 100 may be fused together. While one penetrable fusing element 615 is illustrated, the number of penetrable fusing elements 615 within each functional element 100 may be more than one.

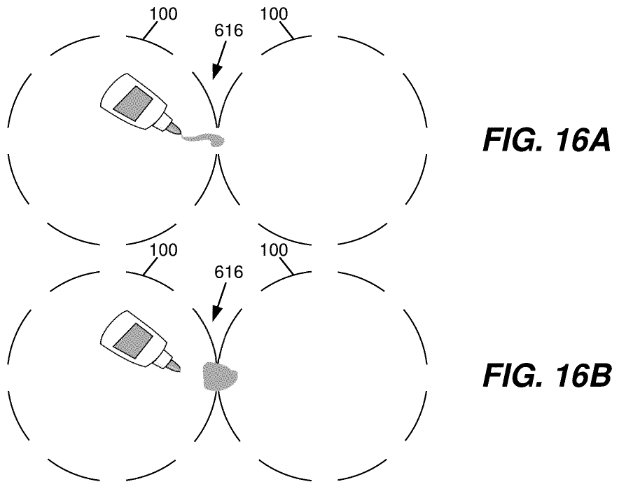

FIGS. 16A and 16B schematically illustrate an example of fusing functional elements, such as functional elements 100. In one example, functional elements 100 include flowable fusing elements 616 to fuse adjacent functional elements 100. In one implementation, flowable fusing element 616 includes an adhesive. The adhesive, for example, may be expelled, released or discharged through or from pores or openings of the shell or housing of functional elements 100 or dispensed from a tip of an internal apparatus, as an example of actuator 114 (FIG. 1), at a location corresponding to the received coordinates (e.g., elevation/azimuth). As such, the adhesive may diffuse into pores or openings of an adjacent functional element 100 and create a bond on cure, such that adjacent functional elements 100 may be fused together, as schematically illustrated, for example, in FIG. 16B.

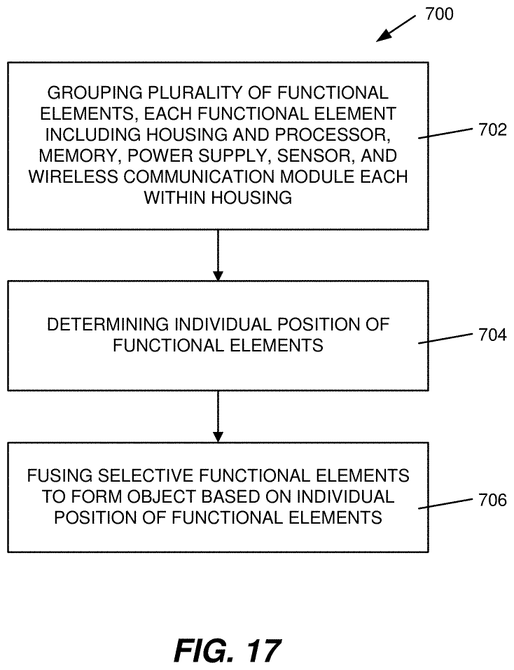

FIG. 17 is a flow diagram illustrating an example of a method 700 of three-dimensional forming of an object, such as object 20, as schematically illustrated, for example, in FIG. 9 and FIGS. 10A, 10B, 10C.

In one example, at 702, method 700 includes grouping a plurality of functional elements, such as functional elements 100, with each of the functional elements including a housing, such as housing 102, and a processor, such as processor 104, memory, such as memory 106, power supply, such as power supply 108, sensor, such as sensor 110, and wireless communication module, such as wireless communication module 112, each within the housing, as schematically illustrated, for example, in FIG. 1.

As such, at 704, method 700 includes determining an individual position of each of the functional elements, such as determining individual position 120 of each functional element 100, as schematically illustrated, for example, in FIG. 9.

As such, at 706, method 700 includes fusing selective ones of the functional elements to form the object based on the individual position of each of the functional elements, such as fusing selective functional elements 100 to form object 20 based on individual position 120 of each functional element 100, as schematically illustrated, for example, in FIG. 9 and FIGS. 10A, 10B, 10C.

Although illustrated and described as separate and/or sequential steps, the method may include a different order or sequence of steps, and may combine one or more steps or perform one or more steps concurrently, partially or wholly.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. A system for three-dimensional forming of an object, comprising:
a set of functional elements, each of the functional elements including a housing and a processor, memory, power supply, sensor, and wireless communication module each within the housing;
a position module to determine an individual position of each of the functional elements; and
a fuse module to determine instructions to fuse selective ones of the functional elements based on the individual position of each of the functional elements to form the object with the selective ones of the functional elements.

2. The system of claim 1, wherein the fuse module is to receive a specified shape for the object and determine the instructions to fuse selective ones of the functional elements based on the specified shape for the object.

3. The system of claim 2, wherein the fuse module is to virtually position the specified shape for the object within a three-dimensional space within the set of functional elements and determine the instructions to fuse selective ones of the functional elements based on the individual position of adjacent ones of the functional elements within the three-dimensional space.

4. The system of claim 2, wherein the fuse module is to receive the specified shape for the object as three-dimensional data.

5. The system of claim 1, wherein the fuse module is to communicate the fuse instructions with the selective ones of the functional elements.

6. The system of claim 5, wherein the fuse module is to communicate the fuse instructions with each of the functional elements and only the selective ones of the functional elements are to respond to the fuse instructions.

7. The system of claim 5, wherein the fuse module is to communicate the fuse instructions with at least one of the selective ones of the functional elements, and the at least one of the selective ones of the functional elements is to communicate the fuse instructions with another of the selective ones of the functional elements.

8. The system of claim 1, wherein the instructions to fuse selective ones of the functional elements include coordinates of a location at which the selective ones of the functional elements are to be fused to form the object.

9. The system of claim 8, wherein the coordinates include elevation and azimuth.

10. The system of claim 1, wherein the fuse module is to issue instructions to unfuse the selective ones of the functional elements as fused to form the object.

11. A system for three-dimensional forming of an object, comprising:
an accumulation of functional elements, each of the functional elements including a housing and a processor, memory, power supply, sensor, and wireless communication module each within the housing,
wherein, based on a respective position within the accumulation of functional elements, selective ones of the functional elements are fused to adjacent ones of the functional elements to form the object.

12. The system of claim 11, wherein the selective ones of the functional elements are fused to the adjacent ones of the functional elements by at least one of positionable fusing elements of the selective ones of the functional elements, individually addressable fusing elements of the selective ones of the functional elements, penetrable fusing elements of the selective ones of the functional elements, and flowable fusing elements of the selective ones of the functional elements.

13. A method of three-dimensional forming of an object, comprising:
grouping a plurality of functional elements, each of the functional elements including a housing and a processor, memory, power supply, sensor, and wireless communication module each within the housing;
determining an individual position of each of the functional elements; and
fusing selective ones of the functional elements to form the object based on the individual position of each of the functional elements.

14. The method of claim 11, further comprising:
receiving a specified shape for the object; and
virtually positioning the specified shape for the object within a three-dimensional space within the grouping of functional elements,
wherein fusing the selective ones of the functional elements to form the object includes fusing the selective ones of the functional elements based on the individual position of adjacent ones of the functional elements within the three-dimensional space.

15. The method of claim 11, further comprising:
determining fuse instructions for the fusing of the selective ones of the functional elements; and
communicating the fuse instructions with the selective ones of the functional elements.
